(19) United States
(12) Patent Application Publication
(10) Pub. No.: US 2017/0234480 A1
(43) Pub. Date: Aug. 17, 2017

(54) TREE AND POLE SUPPORT

(71) Applicant: Poly-Tech Industrial Inc., Huntersville, NC (US)

(72) Inventor: Daniel Pompei Cedrone, Huntersville, NC (US)

(21) Appl. No.: 15/430,914

(22) Filed: Feb. 13, 2017

Related U.S. Application Data
(60) Provisional application No. 62/295,806, filed on Feb. 16, 2016.

(51) Int. Cl. F16M 13/02; A47G 33/12; E04H 12/22; A47G 33/04

(52) U.S. Cl. CPC F16M 13/02; A47G 33/04; A47G 33/12; E04H 12/2238

(57) ABSTRACT

A support apparatus includes: an extension member with opposed first and second ends; a yoke disposed at the first end of the extension member; and a foot disposed at the second end of the extension member.

### BACKGROUND OF THE INVENTION

This invention relates generally to home decorations and more particularly to physical supports for decorations such Christmas trees.

Christmas trees are a common type of holiday decoration. A natural or artificial tree is usually supported by a relatively small tripod-type base at its root end, and hung with decorations such as electric lights and glass or ceramic ornaments.

One problem with a Christmas tree is that it can be heavy and have a high center of gravity (“top-heavy”). A Christmas tree can easily be knocked over by a child or a pet. If a tree falls over it may it may damage or destroy ornaments having significant financial or sentimental value. It could also cause significant damage to the home or its furnishings or injury to occupants. Furthermore, in extreme cases, broken electric lights or spilled water could cause a fire or other structural damage.

### BRIEF SUMMARY OF THE INVENTION

This problem is addressed by a support that can be placed around a tree or pole to increase its stability.

According to one aspect of the technology described herein, a support apparatus includes: an extension member with opposed first and second ends; a yoke disposed at the first end of the extension member; and a foot disposed at the second end of the extension member.

### BRIEF DESCRIPTION OF THE DRAWINGS

The invention may be best understood by reference to the following description taken in conjunction with the accompanying drawing figures, in which:

FIG. 1 is a schematic side view of a support;

FIG. 2 is an exploded view of the support shown in FIG. 1;

FIG. 3 is a partially-broken-away top plan view of a yoke of the support shown in FIG. 1;

FIG. 4 is a side elevation view of the yoke shown in FIG. 3;

FIG. 5 is a schematic side view showing the support of FIG. 1 being used to support a tree;

FIG. 6 is a schematic top plan view showing an array of the supports of FIG. 1 arranged about a tree trunk in a tripod pattern;

FIG. 7 is a schematic top plan view of an alternative support; and

FIG. 8 is a schematic perspective view of the support of FIG. 7.

### DETAILED DESCRIPTION OF THE INVENTION

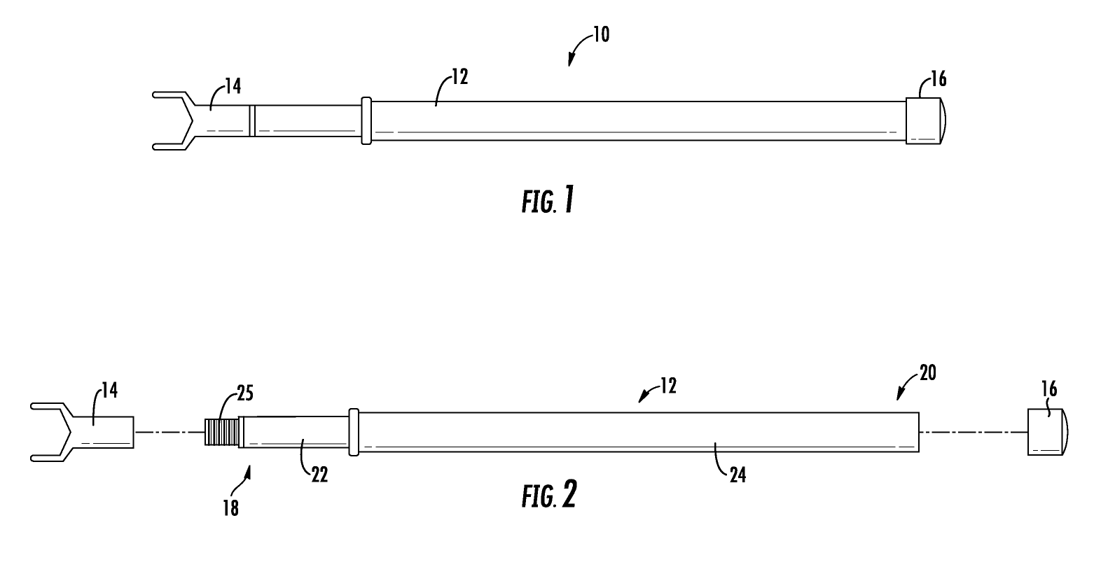

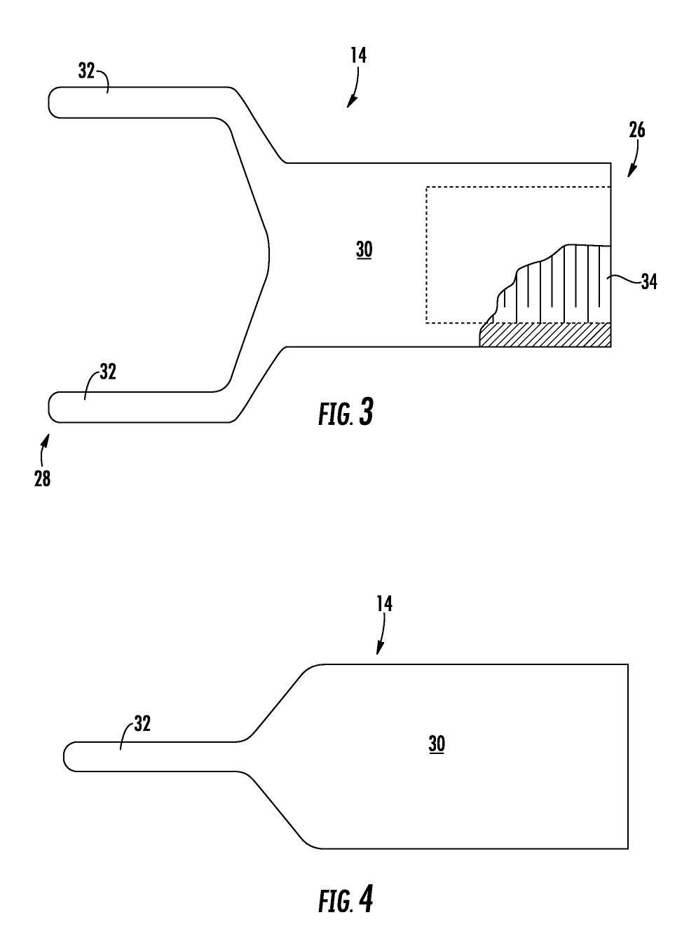

Referring to the drawings wherein identical reference numerals denote the same elements throughout the various views, FIGS. 1 and 2 illustrate an exemplary support 10. The basic components of the support 10 are an extension member 12, a yoke 14, and a foot 16.

The extension member 12 is an elongated element with upper and lower ends 18, 20 respectively. The extension member 12 may have a fixed or adjustable length. As used herein, the term “adjustable” refers to the length being selectively variable without having to be permanently changed, i.e. the length can be adjusted without permanently removing or adding material. Nonlimiting examples of adjustable structures include modular structures, sliding structures, and telescoping structures. In the illustrated example, the extension member 12 includes an upper tube 22 which telescopes inside a lower tube 24. An internal detent mechanism or a twist-lock mechanism (not shown) is provided to fix the extension member 12 at any desired length. This type of telescoping device is sold commercially for use as an extension handle, e.g. for being attached to a paint roller or similar tool.

The upper end 18 of the extension member 12 includes some means for attachment to the yoke 14, such as an interlocking surface, a fastener, or a latching mechanism. In the illustrated example, the upper end 18 has male threads 25 formed thereon.

Optionally, the extension member 12 may be decorated, for example by painting, powder coating, anodization, printing, or covering with material such as vinyl wrap. For example, the decoration may incorporate a holiday theme, or it may incorporate a color or pattern intended to camouflage the appearance of the support 10.

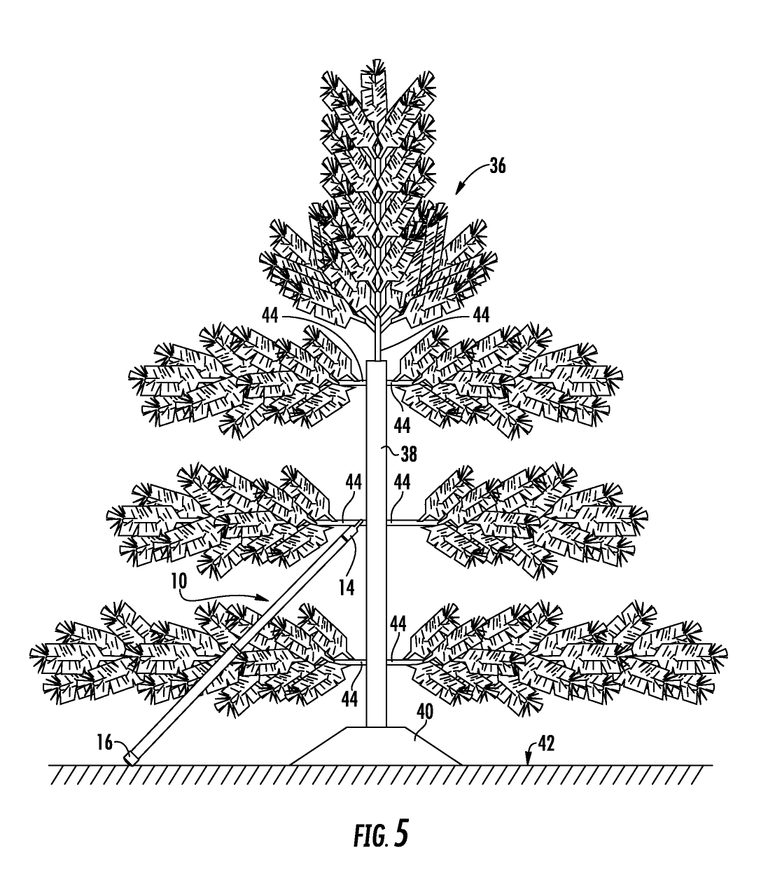

Referring to FIGS. 3 and 4, the yoke 14 is generally Y-shaped with a proximate end 26 and a distal end 28. The yoke 14 includes a body 30 with a pair of spaced-apart fingers 32 extending therefrom, adjacent the distal end 28. The fingers 32 may be generally parallel to each other. The spacing between the fingers 32 may be selected sufficient to receive a portion of a branch or trunk of a tree. By way of example and not of limitation, the spacing between the fingers 32 may be in a range of a fraction of an inch to several inches. The yoke 14 includes some means for attachment to the upper end 18 of the extension member 12, such as an interlocking surface, a fastener, or a latching mechanism. In the illustrated example, the body 30 of the yoke 14 incorporates female threads 34 adjacent the proximate end 26, which engage the male threads 25 of the extension member 12.

The yoke 14 may be manufactured from any material providing adequate strength for the purpose of coupling to the extension member 12 and bearing against a tree. Non-limiting examples of suitable materials include polymers, metals, and wood. In the illustrated example the yoke 14 is an integral, unitary, or monolithic component molded from plastic such as polyethylene.

The foot 16 is configured to engage a floor or ground surface to prevent slippage of the support 10. The foot 16 may incorporate one or more features to promote friction and/or traction, such as a soft or rough surface, or pins, ribs or spikes. In the illustrated example, the foot 16 is a cap made from a resilient material such as natural or synthetic rubber, sized to engage the lower end 20 of the extension member 12 in a friction fit.

Optionally, the yoke 14 and the foot 16 may be provided as a kit and used to assemble a support 10 using an existing telescoping extension member 12 as described above.

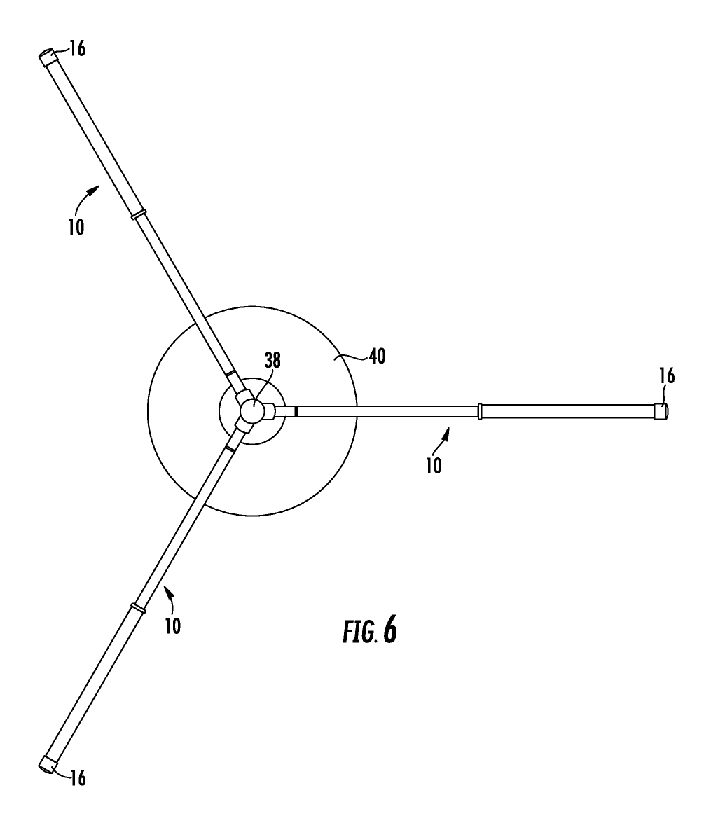

FIG. 5 shows how the support 10 may be used to brace a Christmas tree. A representative tree 36 includes a central trunk 38 supported by a base 40 which in turn rests on a floor 42. A plurality of branches 44 extend outward from the trunk 38. The yoke 14 receives the trunk 38 and/or a branch 44 to prevent the upper end 18 from disengaging. The foot 16 rests against or engages the floor 42. The support 10 extends upward from the floor 42 at an acute angle. The support 10 thus directly braces the tree 36 from toppling in a direction towards the support 10, and provides a wider effective base for the tree 36. The angle and/or length of the support 10 may be selected to provide sufficient stability and resistance to toppling while minimizing the exposed portion of the support 10.

As shown in FIG. 6, a number of supports 10 may be arrayed around the trunk 38 as necessary to provide complete support to the tree 36. Each support 10 braces the tree 36 against falling in a direction in line with the support 10, but does not provide lateral support. If the tree 36 is freestanding, a minimum of three supports 10 arrayed at equal spacings (e.g. 120°) will brace the tree 36 against falling in any direction. If the tree 36 is already positioned such that it is protected against falling in one or more directions, for example if the tree 36 is placed in an interior corner of a room, then fewer supports 10 may be sufficient.

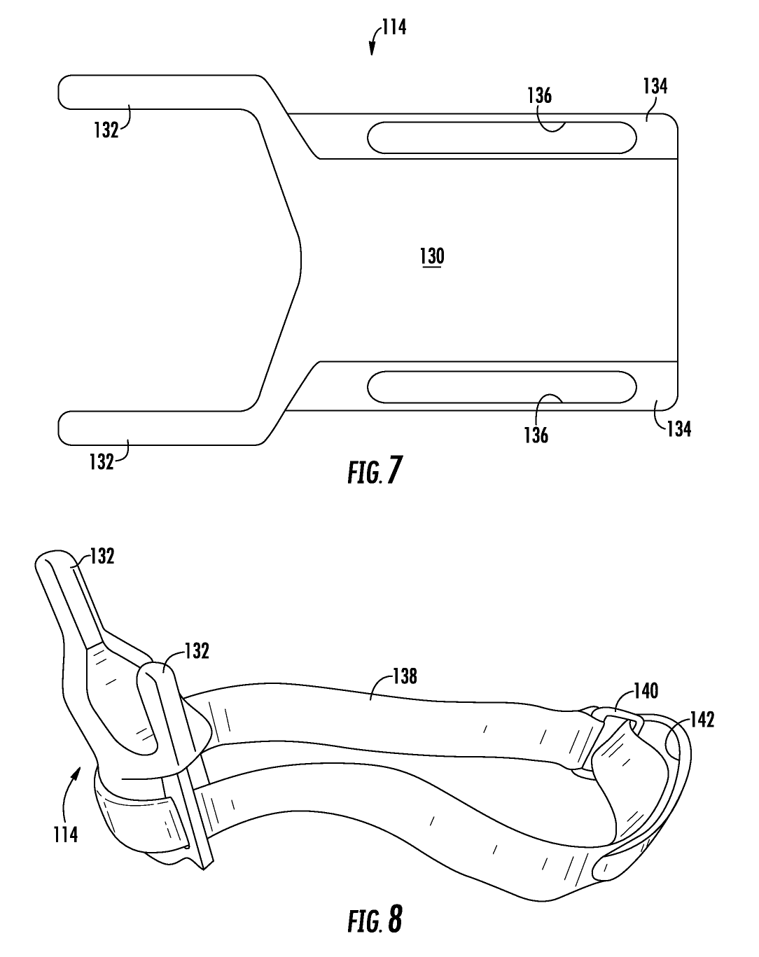

FIG. 7 illustrates an alternative yoke 114 similar in construction to the yoke 14 described above. The yoke 114 is interchangeable in the assembly of the support 10 with the yoke 14 described above. Elements of the yoke 14 not specifically described may be considered identical to the yoke 14. The yoke 114 is generally Y-shaped with a body 130 with a pair of spaced-apart fingers 132 extending therefrom. The yoke 114 includes some means for attachment to the upper end 18 of the extension member 12, as described above. A pair of ribs 134 are disposed on opposite sides of the body 130. Each rib 134 as a slot 136 formed therethrough.

FIG. 8 illustrates the yoke 114 with an adjustable strap 138 threaded through the slots 136. The strap 138 is adjustable in length and may be secured with a fastening mechanism such as the illustrated buckle 140 and hook-and-loop fastener 142. When the buckle 140 and hook-and-loop fastener 142 are released the strap 138 defines an open shape with two free ends that may be wrapped around a tree or pole. When the buckle 140 and hook-and-loop fastener 142 are secured, the free ends are fastened together and the strap 138 defines a closed loop in cooperation with the yoke 114. In use with the support 10, the strap 138 may be used to secure the yoke 114 to the pole, trunk, or branch to ensure that the support 10 does not slip out of position.

While the support 10 has been described in the context of supporting a Christmas tree, the principles described herein may be adapted to other uses. In particular, the support 10 to be used to support any upstanding structure such as a pole, rod, or bar.

Furthermore, the support 10 or 110 may also be used as a tool, with the yoke 14 or 114 serving a hook or gripper (optionally using the strap 138 for security) and the extension 12 serving as a long handle. Used this way, the support 10 or 110 can be used to hold objects such as lights, ornaments, etc. These items can be lifted up and installed on, or removed from, the tree 36 or other locations at elevations above the user's natural reach.

The foregoing has described a tree and pole support. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstracts and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstracts and drawings), or to any novel one, or any novel combination, of the steps of any method or process so disclosed.

What is claimed is:

1. A support apparatus, comprising:
an extension member with opposed first and second ends;
a yoke disposed at the first end of the extension member; and
a foot disposed at the second end of the extension member.

2. The apparatus of claim 1 wherein an overall length of the extension member between the first and second ends is adjustable.

3. The apparatus of claim 1 wherein the foot comprises a resilient material.

4. The apparatus of claim 3 wherein the foot is engaged with the second end of the extension member in a friction fit.

5. The apparatus of claim 1 wherein the yoke includes a body attached to the first end of the extension member, and a pair of spaced-apart fingers extending away from the body.

6. The apparatus of claim 5, wherein:
the extension member includes first threads formed at the first end; and
the body of the yoke incorporates second threads that engage the threads of the extension.

7. The apparatus of claim 1 wherein the yoke is a unitary generally Y-shaped component having proximate and distal ends, the yoke defined by a body disposed adjacent the proximate end and a pair of spaced-apart fingers adjacent the distal end, the body including female threads formed therein.

8. The apparatus of claim 1 wherein the yoke includes a strap attached thereto, the strap having a pair of free ends, and a fastening mechanism operable to connect the free ends together so as to define a closed loop in cooperation with the yoke.

9. The apparatus of claim 8 wherein the yoke includes a slot formed therein and the strap is threaded through the slot.

10. The apparatus of claim 8 wherein the fastening device comprises a buckle and a hook-and-loop fastener.

11. A method for supporting a tree or pole in an upright position on a floor or ground surface, comprising:
placing the support of claim 1 around the tree or pole, with the yoke engaging the tree or pole, the foot engaging the floor or ground surface, and the support extending outward from the tree or pole in a supporting position, so as to brace the tree or pole from toppling in a direction towards the support.

12. The method of claim 11 further comprising placing a plurality of the supports according to claim 1 arrayed around the tree or pole, each of the supports having its respective yoke engaging the tree or pole, its respective foot engaging the floor or ground surface, and the respective support extending outward from the tree or pole in a supporting position, so as to brace the tree or pole from toppling in a direction towards the respective support.

13. A method for supporting a tree or pole in an upright position on a floor or ground surface, comprising:
placing the support of claim 8 around the tree or pole, with the yoke engaging the tree or pole, the foot engaging the floor or ground surface, and the support extending outward from the tree or pole so as to brace the tree or pole from toppling in a direction towards the support; and
securing the strap to the tree or pole to prevent the support from slipping out of position.

14. The method of claim 13 further comprising:
placing a plurality of the supports according to claim 8 arrayed around the tree or pole, each of the supports having its respective yoke engaging the tree or pole, its respective foot engaging the floor or ground surface, and the respective support extending outward from the tree or pole in a supporting position, so as to brace the tree or pole from toppling in a direction towards the respective support; and
securing the respective strap of each of the supports to the tree or pole to prevent the respective support from slipping out of position.
